(19) United States
(12) Patent Application Publication
(10) Pub. No.: US 2011/0136988 A1
(43) Pub. Date: Jun. 9, 2011

(54) CONDENSATION POLYMERS WITH MODIFIED PROPERTIES

(75) Inventors: Florian Hans Maximilian Graichen, Victoria (AU); Michael Shane O'Shea, Victoria (AU); Gary Peeters, Victoria (AU); Andrew Charles Warden, Australian Capital Territory (AU)

(73) Assignees: Commonwealth Scientific an dIndustrial Research Organisation, Campbell (AU); Grains Research and Development Corporation, Barton (AU)

(21) Appl. No.: 12/988,434

(22) PCT Filed: Apr. 17, 2009
(86) PCT No.: PCT/AU2009/000478

§ 371 Date: Jan. 18, 2011

(30) Foreign Application Priority Data
Apr. 18, 2008 (AU) 2008901957

(51) Int. Cl. C08G 63/91

(52) U.S. Cl. 525/411; 525/419; 525/420

(57) ABSTRACT

The present invention relates to a method of preparing a polymer composition, the method comprising melt mixing an aliphatic condensation polymer with a cyclic ester of general formula (I) where X is an optionally substituted aliphatic hydrocarbon having 2 or more carbon atoms present in the cycle.

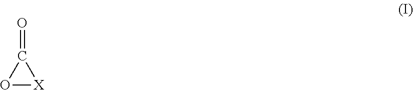

### FIELD OF THE INVENTION

The present invention relates in general to condensation polymers. In particular, the invention relates to aliphatic condensation polymers having modified properties

### BACKGROUND OF THE INVENTION

Condensation polymers such as polyesters and polyamides may be prepared with a diverse array of physical and chemical properties. For example, condensation polymers may vary widely in their stiffness, hardness, elasticity, tensile strength, density, and may or may not be susceptible to biodegradation.

Such diverse properties lend this class of polymer utility in many and varied applications including food packaging, building materials, medical implants, to name but a few.

As a subset of condensation polymers, aliphatic condensation polymers present their own unique physical and chemical properties. For example, aliphatic polyesters are known to exhibit good biodegradability. However, relative to their non-aliphatic counterparts and other commercial polymers (e.g. polyvinyl chloride and polypropylene), aliphatic condensation polymers can lack the physical and/or chemical properties required for use in certain applications. For example, despite exhibiting good biodegradability, polylactic acid has relatively poor flexibility and its use in film based applications (e.g. as a packaging material) is limited.

A number of techniques for improving the physical and/or chemical properties of aliphatic condensation polymers have been developed. For example, specialty monomers that can influence the physical and/or chemical properties of the polymer may be used in conjunction with the conventional monomers during the condensation polymerisation manufacturing process. However, deriving new and improved properties of condensation polymers in this way necessarily requires the use of rather specialised condensation polymerisation equipment.

An opportunity therefore remains to develop alternative methodology for preparing aliphatic condensation polymers with new and/or improved properties.

### SUMMARY OF THE INVENTION

The present invention provides a method of preparing a polymer composition, the method comprising melt mixing an aliphatic condensation polymer with a cyclic ester of general formula (I):

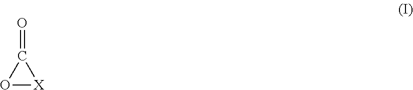

where X is an optionally substituted aliphatic hydrocarbon having 2 or more carbon atoms present in the cycle.

By melt mixing the cyclic ester (I) with a preformed aliphatic condensation polymer, it has been found that the polymer backbone of the condensation polymer can be modified so as to incorporate the ring opened residue of the cyclic ester. Furthermore, this process has been found to occur without significant loss of molecular weight of the condensation polymer, thereby minimising if not avoiding all together the need for any subsequent processing to build the molecular weight of the modified polymer.

The resulting modified condensation polymer includes as part its polymeric backbone the ring opened residue of the cyclic ester. The presence of the ring opened residue as part of the polymer backbone is believed to impart new and/or improved properties to the modified condensation polymer. In particular, the structure of the cyclic ester can be varied such that the incorporated ring opened residue can impart different properties to the condensation polymer.

Accordingly, the present invention further provides a method for modifying an aliphatic condensation polymer, the method comprising melt mixing the condensation polymer with a cyclic ester of general formula (I).

The methods of the invention can advantageously be performed using conventional melt mixing equipment known in the art. Generally, the methods will be performed by introducing the cyclic ester and the condensation polymer individually or collectively into the appropriate melt mixing equipment. For example, the cyclic ester might be introduced to condensation polymer already in a molten state, or a mixture of the cyclic ester and the condensation polymer may be subjected to melt mixing.

The cyclic ester might also be provided in the form of a composition such as a masterbatch or concentrate which is subsequently let down into an aliphatic condensation polymer to be modified. The composition will generally comprise the cyclic ester and one or more polymers (commonly referred to as a carrier polymer(s)). The carrier polymer may be the same or different to the condensation polymer that is to be modified. In one embodiment, the carrier polymer(s) is an aliphatic condensation polymer. The composition may be a physical blend of the cyclic ester and one or more carrier polymers, and/or may itself be prepared by melt mixing the cyclic ester with one or more carrier polymers.

The present invention therefore also provides a polymer composition for modifying an aliphatic condensation polymer, the composition comprising one or more carrier polymers and a cyclic ester of general formula (I) and/or a product formed by melt mixing a composition comprising one or more carrier polymers and a cyclic ester of general formula (I).

In one embodiment, the polymer composition comprises an aliphatic condensation polymer and a cyclic ester of general formula (I) and/or a product formed by melt mixing a composition comprising an aliphatic condensation polymer and a cyclic ester of general formula (I).

Aliphatic condensation polymers modified in accordance with the invention have been found to exhibit new and/or improved properties such as improved flexibility relative to the condensation polymer prior to being modified.

The cyclic ester (I) used in accordance with the invention can advantageously be prepared using hydroxycarboxylic acids, a renewable resource that can be derived from plants and animals.

Further aspects of the invention are described below.

### DETAILED DESCRIPTION OF THE INVENTION

As used herein, the expression “condensation polymer” is intended to mean a polymer that has been formed via a condensation or step-wise polymerisation reaction. Examples of condensation polymers include polyesters, polyamide and copolymers thereof. In one embodiment of the invention, the condensation polymers used are polyesters, polyamides, and copolymers thereof.

Condensation polymers used in accordance with the invention are “aliphatic condensation polymers”. By “aliphatic” condensation polymers is meant that the polymer backbone does not incorporate an aromatic moiety. Thus, polyethylene terephthalate (i.e. PET) is not an aliphatic polyester.

By the expression “polymer backbone” is meant the main structure of the polymer on to which substituents may be attached. The main structure of the polymer may be linear or branched.

The condensation polymers may be acyclic (i.e. where the polymer backbone does not incorporate a cyclic moiety). Although the polymer backbone of the aliphatic condensation polymers will not incorporate an aromatic moiety (and possibly not a cyclic moiety), an aromatic or cyclic moiety may nonetheless be present in a position that is pendant from the polymer backbone. However, the aliphatic condensation polymers used in accordance with the invention will not generally comprise a pendant aromatic or cyclic moiety.

Aliphatic polyesters that may be used in the invention include homo- and copolymers of poly(hydroxyalkanoates) and homo- and copolymers of those aliphatic polyesters derived from the reaction product of one or more alkyldiols with one or more alkyldicarboxylic acids (or acyl derivatives). Miscible and immiscible blends of aliphatic polyesters may also be used.

One class of aliphatic polyester includes poly(hydroxyalkanoates) derived by condensation or ring-opening polymerization of hydroxycarboxylic acids, or derivatives thereof. Suitable poly(hydroxyalkanoates) may be represented by the formula H(O—R^{a}—C(O)—)ₙOH, where R^{a} is an alkylene moiety that may be linear or branched and n is a number from 1 to 20, preferably 1 to 12. R^{a} may further comprise one or more caternary (i.e. in chain) ether oxygen atoms. Generally the R^{a} group of the hydroxycarboxylic acids is such that the pendant hydroxyl group is a primary or secondary hydroxyl group.

Useful poly(hydroxyalkanoates) include, for example, homo- and copolymers of poly(3-hydroxybutyrate), poly(4-hydroxybutyrate), poly(3-hydroxyvalerate), poly(lactic acid) (also known as polylactide), poly(3-hydroxypropanoate), poly(4-hydropcntanoate), poly(3-hydroxypentanoate), poly(3-hydroxyhexanoate), poly(3-hydroxyheptanoate), poly(3-hydroxyoctanoate), polydioxanone, and polycaprolactone, polyglycolic acid (also known as polyglycolide). Copolymers of two or more of the above hydroxycarboxylic acids may also be used, for example, to provide for poly(3-hydroxybutyrate-co-3-hydroxyvalerate), poly(lactate-co-3-hydroxypropanoate) and poly(glycolide-co-p-dioxanone). Blends of two or more of the poly(hydroxyalkanoates) may also be used.

A further class of aliphatic polyester includes those aliphatic polyesters derived from the reaction product of one or more alkyldiols with one or more alkyldicarboxylic acids (or acyl derivatives). Such polyesters have the general formula (II):

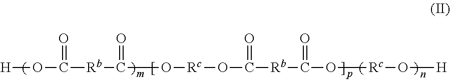

where R^{b} and R^{c} each independently represent an alkylene moiety that may be linear or branched having from 1 to 20, preferably 1 to 12 carbon atoms, and p is a number such that the ester is polymeric, and is preferably a number such that the molecular weight of the aliphatic polyester is 10,000 to 300,000, more preferably from about 30,000 to 200,000. Each m and n is independently 0 or 1. R^{b} and R^{c} may further comprise one or more caternary (i.e. in chain) ether oxygen atoms.

Examples of such aliphatic polyesters include those homo- and copolymers derived from (a) one or more of the following diacids (or derivative thereof): succinic acid, adipic acid, 1,12 dicarboxydodecane, fumaric acid, and maleic acid and (b) one of more of the following diols: ethylene glycol, polyethylene glycol, 1,2-propane diol, 1,3-propanediol, 1,2-propanediol, 1,2-butanediol, 1,3-butanediol, 1,4-butanediol, 1,6-hexanediol, diethylene glycol, and polypropylene glycol, and (c) optionally a small amount, i.e. 0.5-7.0 mole % of a polyol with a functionality greater than two such as glycerol, or pentaerythritol.

Such aliphatic polyesters may include polybutylenesuccinate homopolymer, polybutylene adipate homopolmer, polybutyleneadipate-succinate copolymer, polyethylenesuccinate-adipate copolymer, polyethylene adipate homopolymer.

Common commercially available aliphatic polyesters include polylactide, polyglycolide, polylactide-co-glycolide, poly(L-lactide-co-trimethylene carbonate), poly(dioxanone), poly(butylene succinate), and poly(butylene adipate).

Blends of two or more aliphatic polyesters may also be used in accordance with the invention.

Aliphatic polyamides that may be used in the invention include those characterised by the presence of recurring carbonamide groups that form part of the polymer backbone and which are separated from one another by at least two aliphatic carbon atoms. Suitable aliphatic polyamides therefore include those having recurring units represented by general formulae (III) or (IV):

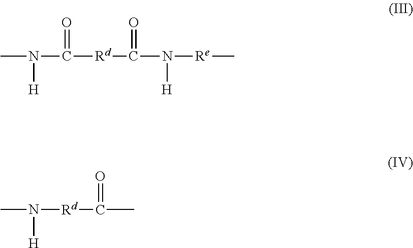

or a combination thereof, in which R^{d} and R^{e} are the same or different and are each independently alkylene groups of at least two carbon atoms, for example alkylene having about two to about 20 carbon atoms, preferably alkylene having about two to about 12 carbon atoms.

Examples of such polyamides are those formed by the reaction of one or more alkydiamines and one or more alkyldicarboxylic acids and include poly(tetramethylene adipamide) (nylon 4,6); poly(hexamethylene adipamide) (nylon 6,6); poly(hexamethylene azelamide) (nylon 6,9); poly(hexamethylene sebacamide) (nylon 6,10); poly(heptamethylene pimelamide) (nylon 7,7); poly(octamethylene suberamide) (nylon 8,8); poly(nonamethylene azelamide) (nylon 9,9); poly(decamethylene azelamide) (nylon 10,9); and the like.

Examples of such polyamides are also those formed by polymerization of alkyl amino acids and derivatives thereof (e.g. lactams) and include poly(4-aminobutyric acid) (nylon 4); poly(6-aminohexanoic acid) (nylon 6); poly(7-amino-heptanoic acid) (nylon 7); poly(8-aminoocatanoic acid) (nylon 8); poly(9-aminononanoic acid) (nylon 9); poly(10-aminodecanoic acid) (nylon 10); poly(11-aminoundecanoic acid) (nylon 11); poly(12-aminododecanoic acid) (nylon 12); and the like.

Blends of two or more aliphatic polyamides may also be used in accordance with the invention.

The cyclic ester used in accordance with the invention is of general formula (I):

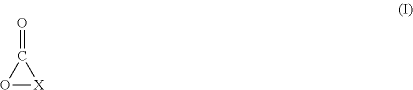

where X is an optionally substituted aliphatic hydrocarbon having two or more carbon atoms present in the cycle.

The hydrocarbon group X in general formula (I) is an optionally substituted aliphatic hydrocarbon having two or more carbon atoms present in the cycle. By “aliphatic” hydrocarbon is meant a non-aromatic hydrocarbon. By two or more carbon atoms being “present in the cycle” is meant that the cyclic ester of general formula (I) is at least a four atom cycle (i.e. a four membered ring), with the hydrocarbon X contributing two carbons atoms to the cycle. The hydrocarbon X may also have a number of carbon atoms that do not form part of or are not present in the cycle. The hydrocarbon X will generally be an acyclic hydrocarbon (i.e. a non-cyclic hydrocarbon). In one embodiment, the hydrocarbon group X is a linear or branched alkylene, alkenylene, or alkynylene group.

The hydrocarbon group X may be saturated or unsaturated. Where the hydrocarbon is unsaturated, it may be mono- or poly-unsaturated, and include both cis- and trans-isomers. The hydrocarbon X will generally have 2 to 25 carbon atoms present in the cycle, preferably 5 to 20 carbon atoms, more preferably 10 to 20 carbon atoms. The hydrocarbon X may be substituted with optional substituents defined herein. In some embodiments the hydrocarbon X is not substituted. In that case, the hydrocarbon group X is preferably a linear alkylene, alkenylene, or alkynylene group.

Where the X group in general formula (I) is an unsaturated aliphatic hydrocarbon group or an aliphatic hydrocarbon group substituted with one or more optional substituents as herein defined that present a reactive functional group, the modified condensation polymers in accordance with the invention can advantageously undergo reaction through the reactive functional groups within or substituted on the hydrocarbon X. For example, where the hydrocarbon group X is unsaturated, the unsaturated bonds may take part in crosslinking reactions (i.e. oxidative crosslinking similar to that which occurs in alkyd paints, or free radical mediated reactions), and free radical mediated grafting reactions. Crosslinking and grafting reactions may also be conducted through reactive functional group substituents on the hydrocarbon group X.

Providing the hydrocarbon group X with one or more reactive functional groups can advantageously enable organic or inorganic moieties to be tethered to the polymer backbone through reaction of the moieties with such groups. The organic or inorganic moieties may be conveniently tethered to the X group of the cyclic ester prior to it being melt mixed with the aliphatic condensation polymer, or tethered to the X group after the cyclic ester has been melt mixed with the aliphatic condensation polymer.

In one embodiment, the X group of general formulae (I) is an aliphatic hydrocarbon comprising conjugated double and/or triple bonds. Preferably, such conjugation is in the form of an yne-yne, ene-ene, yne-yne-yne, yne-yne-ene-, ene-yne-yne or yne-ene-yne moiety.

As used herein, the term “alkyl”, used either alone or in compound words denotes straight chain, branched or cyclic alkyl, for example C₁₋₄₀ alkyl, or C₁₋₂₀ or C₁₋₁₀. Examples of straight chain and branched alkyl include methyl, ethyl, n-propyl, isopropyl, n-butyl, sec-butyl, t-butyl, n-pentyl, 1,2-dimethylpropyl, 1,1-dimethyl-propyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethyl-pentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl, tridecyl, tetradecyl, pentadecyl, hexadecyl, heptadecyl, octadecyl, nonoadecyl, eicosyl and the like. Examples of cyclic alkyl include mono- or polycyclic alkyl groups such as cyclopropyl, cyclobutyl, cyclopentyl, cyclohexyl, cycloheptyl, cyclooctyl, cyclononyl, cyclodecyl and the like. Where an alkyl group is referred to generally as “propyl”, butyl” etc, it will be understood that this can refer to any of straight, branched and cyclic isomers where appropriate. An alkyl group may be optionally substituted by one or more optional substituents as herein defined.

As used herein, term “alkenyl” denotes groups formed from straight chain, branched or cyclic hydrocarbon residues containing at least one carbon to carbon double bond including ethylenically mono-, di- or polyunsaturated alkyl or cycloalkyl groups as previously defined, for example C₂₋₄₀ alkenyl, or C₂₋₂₀ or C₂₋₁₀. Thus, alkenyl is intended to include propenyl, butylenyl, pentenyl, hexaenyl, heptaenyl, octaenyl, nonaenyl, decenyl, undecenyl, dodecenyl, tridecenyl, tetradecenyl, pentadecenyl, hexadecenyl, heptadecenyl, octadecenyl, nondecenyl, eicosenyl hydrocarbon groups with one or more carbon to carbon double bonds. Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3-heptenyl, 1-octenyl, cyclooctenyl, 1-nonenyl, 2-nonenyl, 3-nonenyl, 1-decenyl, 3-decenyl, 1,3-butadienyl, 1,4-pentadienyl, 1,3-cyclopentadienyl, 1,3-hexadienyl, 1,4-hexadienyl, 1,3-cyclohexadienyl, 1,4-cyclohexadienyl, 1,3-cycloheptadienyl, 1,3,5-cycloheptatrienyl and 1,3,5,7-cyclooctatetraenyl. An alkenyl group may be optionally substituted by one or more optional substituents as herein defined.

As used herein the term “alkynyl” denotes groups formed from straight chain, branched or cyclic hydrocarbon residues containing at least one carbon-carbon triple bond including ethylenically mono-, di- or polyunsaturated alkyl or cycloalkyl groups as previously defined, for example, C₂₋₄₀ alkenyl, or C₂₋₂₀ or C₂₋₁₀. Thus, alkynyl is intended to include propynyl, butylynyl, pentynyl, hexaynyl, heptaynyl, octaynyl, nonaynyl, decynyl, undecynyl, dodecynyl, tridecynyl, tetradecynyl, pentadecynyl, hexadecynyl, heptadecynyl, octadecynyl, nondecynyl, eicosynyl hydrocarbon groups with one or more carbon to carbon triple bonds. Examples of alkynyl include ethynyl, 1-propynyl, 2-propynyl, and butynyl isomers, and pentynyl isomers. An alkynyl group may be optionally substituted by one or more optional substituents as herein defined.

An alkenyl group may comprise a carbon to carbon triple bond and an alkynyl group may comprise a carbon to carbon double bond (i.e. so called ene-yne or yne-ene groups).

As used herein, the term “aryl” (or “carboaryl)” denotes any of single, polynuclear, conjugated and fused residues of aromatic hydrocarbon ring systems. Examples of aryl include phenyl, biphenyl, terphenyl, quaterphenyl, naphthyl, tetrahydronaphthyl, anthracenyl, dihydroanthracenyl, benzanthracenyl, dibenzanthracenyl, phenanthrenyl, fluorenyl, pyrenyl, idenyl, azulenyl, chrysenyl. Preferred aryl include phenyl and naphthyl. An aryl group may be optionally substituted by one or more optional substituents as herein defined.

As used herein, the terms “alkylene”, “alkenylene”, and “arylene” are intended to denote the divalent forms of “alkyl”, “alkenyl”, and “aryl”, respectively, as herein defined.

In this specification “optionally substituted” is taken to mean that a group may or may not be substituted or fused (so as to form a condensed polycyclic group) with one, two, three or more of organic and inorganic groups (i.e. the optional substituent) including those selected from: alkyl, alkenyl, alkynyl, carbocyclyl, aryl, heterocyclyl, heteroaryl, acyl, aralkyl, alkaryl, alkheterocyclyl, alkheteroaryl, alkcarbocyclyl, halo, haloalkyl, haloalkenyl, haloalkynyl, haloaryl, halocarbocyclyl, haloheterocyclyl, haloheteroaryl, haloacyl, haloaryalkyl, hydroxy, hydroxyalkyl, hydroxyalkenyl, hydroxyalkynyl, hydroxycarbocyclyl, hydroxyaryl, hydroxyheterocyclyl, hydroxyheteroaryl, hydroxyacyl, hydroxyaralkyl, alkoxyalkyl, alkoxyalkenyl, alkoxyalkynyl, alkoxycarbocyclyl, alkoxyaryl, alkoxyheterocyclyl, alkoxyheteroaryl, alkoxyacyl, alkoxyaralkyl, alkoxy, alkenyloxy, alkynyloxy, aryloxy, carbocyclyloxy, aralkyloxy, heteroaryloxy, heterocyclyloxy, acyloxy, haloalkoxy, haloalkenyloxy, haloalkynyloxy, haloaryloxy, halocarbocyclyloxy, haloaralkyloxy, haloheteroaryloxy, haloheterocyclyloxy, haloacyloxy, nitro, nitroalkyl, nitroalkenyl, nitroalkynyl, nitroaryl, nitroheterocyclyl, nitroheteroayl, nitrocarbocyclyl, nitroacyl, nitroaralkyl, amino (NH₂), alkylamino, dialkylamino, alkenylamino, alkynylamino, arylamino, diarylamino, aralkylamino, diaralkylamino, acylamino, diacylamino, heterocyclamino, heteroarylamino, carboxy, carboxyester, amido, alkylsulphonyloxy, arylsulphenyloxy, alkylsulphenyl, arylsulphenyl, thio, alkylthio, alkenylthio, alkynylthio, arylthio, aralkylthio, carbocyclylthio, heterocyclylthio, heteroarylthio, acylthio, sulfoxide, sulfonyl, sulfonamide, aminoalkyl, aminoalkenyl, aminoalkynyl, aminocarbocyclyl, aminoaryl, aminoheterocyclyl, aminoheteroaryl, aminoacyl, aminoaralkyl, thioalkyl, thioalkenyl, thioalkynyl, thiocarbocyclyl, thioaryl, thioheterocyclyl, thioheteroaryl, thioacyl, thioaralkyl, carboxyalkyl, carboxyalkenyl, carboxyalkynyl, carboxycarbocyclyl, carboxyaryl, carboxyheterocyclyl, carboxyheteroaryl, carboxyacyl, carboxyaralkyl, carboxyesteralkyl, carboxyesteralkenyl, carboxyesteralkynyl, carboxyestercarbocyclyl, carboxyesteraryl, carboxyesterheterocyclyl, carboxyesterheteroaryl, carboxyesteracyl, carboxyesteraralkyl, amidoalkyl, amidoalkenyl, amidoalkynyl, amidocarbocyclyl, amidoaryl, amidoheterocyclyl, amidoheteroaryl, amidoacyl, amidoaralkyl, formylalkyl, formylalkenyl, formylalkynyl, formylcarbocyclyl, formylaryl, formylheterocyclyl, formylheteroaryl, formylacyl, formylaralkyl, acylalkyl, acylalkenyl, acylalkynyl, acylcarbocyclyl, acylaryl, acyiheterocyclyl, acylheteroaryl, acylacyl, acylaralkyl, sulfoxidealkyl, sulfoxidealkenyl, sulfoxidealkynyl, sulfoxidecarbocyclyl, sulfoxidearyl, sulfoxideheterocyclyl, sulfoxideheteroaryl, sulfoxideacyl, sulfoxidearalkyl, sulfonylalkyl, sulfonylalkenyl, sulfonylalkynyl, sulfonylcarbocyclyl, sulfonylaryl, sulfonylheterocyclyl, sulfonylheteroaryl, sulfonylacyl, sulfonylaralkyl, sulfonamidoalkyl, sulfonamidoalkenyl, sulfonamidoalkynyl, sulfonamidocarbocyclyl, sulfonamidoaryl, sulfonamidoheterocyclyl, sulfonamidoheteroaryl, sulfonamidoacyl, sulfonamidoaralkyl, nitroalkyl, nitroalkenyl, nitroalkynyl, nitrocarbocyclyl, nitroaryl, nitroheterocyclyl, nitroheteroaryl, nitroacyl, nitroaralkyl, cyano, sulfate and phosphate groups.

In some embodiments, it may be desirable that a group is optionally substituted with a reactive functional group or moiety. Examples of such reactive functional groups or moieties include epoxy, anhydride, cyclic ester (e.g. lactone or higher cyclic oligoester), cyclic amide (e.g. lactam or higher cyclic oligoamide), oxazoline and carbodimide.

In some embodiments, it may be desirable that a group is optionally substituted with a polymer chain. An example of such a polymer chain includes a polyether chain.

Preferred optional substituents include the aforementioned reactive functional groups or moieties, polymer chains and alkyl, (e.g. C₁₋₆ alkyl such as methyl, ethyl, propyl, butyl, cyclopropyl, cyclobutyl, cyclopentyl or cyclohexyl), hydroxyalkyl (e.g. hydroxymethyl, hydroxyethyl, hydroxypropyl), alkoxyalkyl (e.g. methoxymethyl, methoxyethyl, methoxypropyl, ethoxymethyl, ethoxyethyl, ethoxypropyl etc) alkoxy (e.g. C₁₋₆ alkoxy such as methoxy, ethoxy, propoxy, butoxy, cyclopropoxy, cyclobutoxy), halo, trifluoromethyl, trichloromethyl, tribromomethyl, hydroxy, phenyl (which itself may be further substituted e.g., by C₁₋₆ alkyl, halo, hydroxy, hydroxyC₁₋₆ alkyl, C₁₋₆ alkoxy, haloC₁₋₆alkyl, cyano, nitro OC(O)C₁₋₆ alkyl, and amino), benzyl (wherein benzyl itself may be further substituted e.g., by C₁₋₆ alkyl, halo, hydroxy, hydroxyC₁₋₆alkyl, C₁₋₆ alkoxy, haloC₁₋₆ alkyl, cyano, nitro OC(O)C₁₋₆ alkyl, and amino), phenoxy (wherein phenyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), benzyloxy (wherein benzyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), amino, alkylamino (e.g. C₁₋₆ alkyl, such as methylamino, ethylamino, propylamino etc), dialkylamino (e.g. C₁₋₆ alkyl, such as dimethylamino, diethylamino, dipropylamino), acylamino (e.g. NHC(O)CH₃), phenylamino (wherein phenyl itself may be further substituted e.g., by C₁₋₆ alkyl, halo, hydroxy hydroxyC₁₋₆ alkyl, C₁₋₆ alkoxy, haloC₁₋₆ alkyl, cyano, nitro OC(O)C₁₋₆ alkyl, and amino), nitro, formyl, —C(O)-alkyl (e.g. C₁₋₆ alkyl, such as acetyl), O—C(O)-alkyl (e.g. C₁₋₆alkyl, such as acetyloxy), benzoyl (wherein the phenyl group itself may be further substituted e.g., by C₁₋₆ alkyl, halo, hydroxy hydroxyC₁₋₆ alkyl, C₁₋₆ alkoxy, haloC₁₋₆ alkyl, cyano, nitro OC(O)C₁₋₆alkyl, and amino), replacement of CH₂ with C═O, CO₂H, CO₂alkyl (e.g. C₁₋₆ alkyl such as methyl ester, ethyl ester, propyl ester, butyl ester), CO₂phenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONH₂, CONHphenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONHbenzyl (wherein benzyl itself may be further substituted e.g., by C₁₋₆ alkyl, halo, hydroxy hydroxyl C₁₋₆ alkyl, C₁₋₆ alkoxy, halo C₁₋₆ alkyl, cyano, nitro OC(O)C₁₋₆ alkyl, and amino), CONHalkyl (e.g. C₁₋₆ alkyl such as methyl ester, ethyl ester, propyl ester, butyl amide) CONHdialkyl (e.g. C₁₋₆ alkyl)aminoalkyl (e.g., HN C₁₋₆ alkyl-, C₁₋₆alkylHN—C₁₋₆ alkyl- and (C₁₋₆ alkyl)₂N—C₁₋₆ alkyl-), thioalkyl (e.g., HS C₁₋₆ alkyl-), carboxyalkyl (e.g., HO₂CC₁₋₆ alkyl-), carboxyesteralkyl (e.g., C₁₋₆ alkylO₂CC₁₋₆ alkyl-), amidoalkyl (e.g., H₂N(O)CC₁₋₆ alkyl-, H(C₁₋₆ alkyl)N(O)CC₁₋₆ alkyl-), formylalkyl (e.g., OHCC₁₋₆alkyl-), acylalkyl (e.g., C₁₋₆ alkyl(O)CC₁₋₆alkyl-), nitroalkyl (e.g., O₂NC₁₋₆alkyl-), sulfoxidealkyl (e.g., R(O)SC₁₋₆ alkyl, such as C₁₋₆ alkyl(O)SC₁₋₆ alkyl-), sulfonylalkyl (e.g., R(O)₂SC₁₋₆ alkyl- such as C₁₋₆ alkyl(O)₂SC₁₋₆ alkyl-), sulfonamidoalkyl (e.g., ₂HRN(O)SC₁₋₆alkyl, H(C₁₋₆alkyl)N(O)SC₁₋₆alkyl-).

In some embodiments, it may be preferable that the aliphatic hydrocarbon group X is optionally substituted with a cyclic ester, cyclic amide, or polyether chain.

The term “halogen” (“halo”) denotes fluorine, chlorine, bromine or iodine (fluoro, chloro, bromo or iodo). Preferred halogens are chlorine, bromine or iodine.

The term “carbocyclyl” includes any of non-aromatic monocyclic, polycyclic, fused or conjugated hydrocarbon residues, preferably C₃₋₂₀ (e.g. C₃₋₁₀ or C₃₋₈). The rings may be saturated, e.g. cycloalkyl, or may possess one or more double bonds (cycloalkenyl) and/or one or more triple bonds (cycloalkynyl). Particularly preferred carbocyclyl moieties are 5-6-membered or 9-10 membered ring systems. Suitable examples include cyclopropyl, cyclobutyl, cyclopentyl, cyclohexyl, cycloheptyl, cyclooctyl, cyclononyl, cyclodecyl, cyclopentenyl, cyclohexenyl, cyclooctenyl, cyclopentadienyl, cyclohexadienyl, cyclooctatetraenyl, indanyl, decalinyl and indenyl.

The term “heterocyclyl” when used alone or in compound words includes any of monocyclic, polycyclic, fused or conjugated hydrocarbon residues, preferably C₃₋₂₀ (e.g. C₃₋₁₀ or C₃₋₈) wherein one or more carbon atoms are replaced by a heteroatom so as to provide a non-aromatic residue. Suitable heteroatoms include O, N, S, P and Se, particularly O, N and S. Where two or more carbon atoms are replaced, this may be by two or more of the same heteroatom or by different heteroatoms. The heterocyclyl group may be saturated or partially unsaturated, i.e. possess one or more double bonds. Particularly preferred heterocyclyl are 5-6 and 9-10 membered heterocyclyl. Suitable examples of heterocyclyl groups may include azridinyl, oxiranyl, thiiranyl, azetidinyl, oxetanyl, thietanyl, 2H-pyrrolyl, pyrrolidinyl, pyrrolinyl, piperidyl, piperazinyl, morpholinyl, indolinyl, imidazolidinyl, imidazolinyl, pyrazolidinyl, thiomorpholinyl, dioxanyl, tetrahydrofuranyl, tetrahydropyranyl, tetrahydropyrrolyl, tetrahydrothiophenyl, pyrazolinyl, dioxalanyl, thiazolidinyl, isoxazolidinyl, dihydropyranyl, oxazinyl, thiazinyl, thiomorpholinyl, oxathianyl, dithianyl, trioxanyl, thiadiazinyl, dithiazinyl, trithianyl, azepinyl, oxepinyl, thiepinyl, indenyl, indanyl, 3H-indolyl, isoindolinyl, 4H-quinolazinyl, chromenyl, chromanyl, isochromanyl, pyranyl and dihydropyranyl.

The term “heteroaryl” includes any of monocyclic, polycyclic, fused or conjugated hydrocarbon residues, wherein one or more carbon atoms are replaced by a heteroatom so as to provide an aromatic residue. Preferred heteroaryl have 3-20 ring atoms, e.g. 3-10. Particularly preferred heteroaryl are 5-6 and 9-10 membered bicyclic ring systems. Suitable heteroatoms include, O, N, S, P and Se, particularly O, N and S. Where two or more carbon atoms are replaced, this may be by two or more of the same heteroatom or by different heteroatoms. Suitable examples of heteroaryl groups may include pyridyl, pyrrolyl, thienyl, imidazolyl, furanyl, benzothienyl, isobenzothienyl, benzofuranyl, isobenzofuranyl, indolyl, isoindolyl, pyrazolyl, pyrazinyl, pyrimidinyl, pyridazinyl, indolizinyl, quinolyl, isoquinolyl, phthalazinyl, 1,5-naphthyridinyl, quinozalinyl, quinazolinyl, quinolinyl, oxazolyl, thiazolyl, isothiazolyl, isoxazolyl, triazolyl, oxadialzolyl, oxatriazolyl, triazinyl, and furazanyl.

The term “acyl” either alone or in compound words denotes a group containing the moiety C═O (and not being a carboxylic acid, ester or amide) Preferred acyl includes C(O)—R^{x}, wherein R^{x} is hydrogen or an alkyl, alkenyl, alkynyl, aryl, heteroaryl, carbocyclyl, or heterocyclyl residue. Examples of acyl include formyl, straight chain or branched alkanoyl (e.g. C₁₋₂₀) such as, acetyl, propanoyl, butanoyl, 2-methylpropanoyl, pentanoyl, 2,2-dimethylpropanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, nonadecanoyl and icosanoyl; cycloalkylcarbonyl such as cyclopropylcarbonyl cyclobutylcarbonyl, cyclopentylcarbonyl and cyclohexylcarbonyl; aroyl such as benzoyl, toluoyl and naphthoyl; aralkanoyl such as phenylalkanoyl (e.g. phenylacetyl, phenylpropanoyl, phenylbutanoyl, phenylisobutylyl, phenylpentanoyl and phenylhexanoyl) and naphthylalkanoyl (e.g. naphthylacetyl, naphthylpropanoyl and naphthylbutanoyl]; aralkenoyl such as phenylalkenoyl (e.g. phenylpropenoyl, phenylbutenoyl, phenylmethacryloyl, phenylpentenoyl and phenylhexenoyl and naphthylalkenoyl (e.g. naphthylpropenoyl, naphthylbutenoyl and naphthylpentenoyl); aryloxyalkanoyl such as phenoxyacetyl and phenoxypropionyl; arylthiocarbamoyl such as phenylthiocarbamoyl; arylglyoxyloyl such as phenylglyoxyloyl and naphthylglyoxyloyl; arylsulfonyl such as phenylsulfonyl and napthylsulfonyl; heterocycliccarbonyl; heterocyclicalkanoyl such as thienylacetyl, thienylpropanoyl, thienylbutanoyl, thienylpentanoyl, thienylhexanoyl, thiazolylacetyl, thiadiazolylacetyl and tetrazolylacetyl; heterocyclicalkenoyl such as heterocyclicpropenoyl, heterocyclicbutenoyl, heterocyclicpentenoyl and heterocyclichexenoyl; and heterocyclicglyoxyloyl such as thiazolyglyoxyloyl and thienylglyoxyloyl. The R^{x} residue may be optionally substituted as described herein.

The term “sulfoxide”, either alone or in a compound word, refers to a group —S(O)R^{y} wherein R^{y} is selected from hydrogen, alkyl, alkenyl, alkynyl, aryl, heteroaryl, heterocyclyl, carbocyclyl, and aralkyl. Examples of preferred R^{y} include C₁₋₂₀alkyl, phenyl and benzyl.

The term “sulfonyl”, either alone or in a compound word, refers to a group S(O)₂—R^{y}, wherein R^{y} is selected from hydrogen, alkyl, alkenyl, alkynyl, aryl, heteroaryl, heterocyclyl, carbocyclyl and aralkyl. Examples of preferred R^{y} include C₁₋₂₀alkyl, phenyl and benzyl.

The term “sulfonamide”, either alone or in a compound word, refers to a group S(O)NR^{y}R^{y} wherein each R^{y} is independently selected from hydrogen, alkyl, alkenyl, alkynyl, aryl, heteroaryl, heterocyclyl, carbocyclyl, and aralkyl. Examples of preferred R^{y} include C₁₋₂₀alkyl, phenyl and benzyl. In a preferred embodiment at least one R^{y} is hydrogen. In another form, both R^{y} are hydrogen.

The term, “amino” is used here in its broadest sense as understood in the art and includes groups of the formula NR^{A}R^{B} wherein R^{A} and R^{B} may be any independently selected from hydrogen, alkyl, alkenyl, alkynyl, aryl, carbocyclyl, heteroaryl, heterocyclyl, aralkyl, and acyl. R^{A} and R^{B}, together with the nitrogen to which they are attached, may also form a monocyclic, or polycyclic ring system e.g. a 3-10 membered ring, particularly, 5-6 and 9-10 membered systems. Examples of “amino” include NH₂, NHalkyl (e.g. C₁₋₂₀alkyl), NHaryl (e.g. NHphenyl), NHaralkyl (e.g. NHbenzyl), NHacyl (e.g. NHC(O)C₁₋₂₀alkyl, NHC(O)phenyl), Nalkylalkyl (wherein each alkyl, for example C₁₋₂₀, may be the same or different) and 5 or 6 membered rings, optionally containing one or more same or different heteroatoms (e.g. O, N and S).

The term “amido” is used here in its broadest sense as understood in the art and includes groups having the formula C(O)NR^{A}R^{B}, wherein R^{A} and R^{B} are as defined as above. Examples of amido include C(O)NH₂, C(O)NHalkyl (e.g. C₁₋₂₀alkyl), C(O)NHaryl (e.g. C(O)NHphenyl), C(O)NHaralkyl (e.g. C(O)NHbenzyl), C(O)NHacyl (e.g. C(O)NHC(O)C₁₋₂₀alkyl, C(O)NHC(O)phenyl), C(O)Nalkylalkyl (wherein each alkyl, for example C₁₋₂₀, may be the same or different) and 5 or 6 membered rings, optionally containing one or more same or different heteroatoms (e.g. O, N and S).

The term “carboxy ester” is used here in its broadest sense as understood in the art and includes groups having the formula CO₂R^{z}, wherein R^{z} may be selected from groups including alkyl, alkenyl, alkynyl, aryl, carbocyclyl, heteroaryl, heterocyclyl, aralkyl, and acyl. Examples of carboxy ester include CO₂C₁₋₂₀alkyl, CO₂aryl (e.g. CO₂phenyl), CO₂aralkyl (e.g. CO₂ benzyl).

The term “heteroatom” or “hetero” as used herein in its broadest sense refers to any atom other than a carbon atom which may be a member of a cyclic organic group. Particular examples of heteroatoms include nitrogen, oxygen, sulfur, phosphorous, boron, silicon, selenium and tellurium, more particularly nitrogen, oxygen and sulfur.

Those skilled in the art will appreciate that a convenient synthetic route to forming cyclic esters of formula (I) is through a condensation reaction of hydroxycarboxylic acids. The cyclic ester of general formula (I) might therefore be conveniently described as a condensation residue of a hydroxycarboxylic acid of general formula (II):

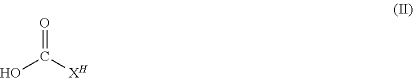

where X^{H} is a hydroxylated optionally substituted aliphatic hydrocarbon having two or more carbon atoms as hereinbefore described.

The group X″ in general formula (II) is a hydroxylated optionally substituted aliphatic hydrocarbon having two or more carbon atoms. By being “hydroxylated” is meant that the aliphatic hydrocarbon has a —OH substituent. Those skilled in the art will appreciate that in order to form the cyclic ester of general formula (I), the carboxylic acid and hydroxyl group of the hydroxycarboxylic acid of general formula (II) will condense so as to form the ester moiety of the cyclic ester. Provided that the cyclic ester can form, there is no particular limitation regarding the position of the hydroxyl group on the optionally substituted aliphatic hydrocarbon. Accordingly, the hydroxyl group may be present as a pendant substituent on the aliphatic hydrocarbon or may be present in a terminal position (i.e. at the end of the aliphatic hydrocarbon chain).

Where the hydroxyl group is located in a pendant position, it will be appreciate that at least part of the hydrocarbon group X will not form part of or be present in the cyclic structure, but instead will present as a pendant group from the cycle as shown below in formula (III):

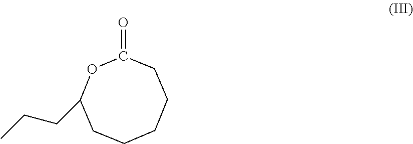

Where the hydroxyl group is located at the end or terminus of the aliphatic hydrocarbon and the aliphatic hydrocarbon is not substituted, all of the hydrocarbon group will form part of or be present in the cycle as shown below in formula (IV):

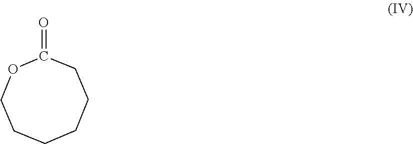

In some embodiments of the invention, the hydroxyl group is located at a terminal position of an unsubstituted acyclic hydrocarbon, and the resulting cyclic ester is therefore also unsubstituted (e.g. as in formula (IV)).

Those skilled in the art will appreciate that the cycle size of a cyclic ester of general formula (I) will vary depending upon the type of hydroxycarboxylic acid that is used. The cyclic ester used may be a mixture of different cyclic esters and might also comprise a mixture of different cycle sizes.

The cyclic ester used in accordance with the invention may conveniently be described in terms of it being formed of a condensed residue of a particular hydroxycarboxylic acid.

Thus, in one embodiment of the invention the cyclic ester used in accordance with the invention is a condensed residue of a hydroxycarboxylic acid general formula (II).

Suitable examples of hydroxycarboxylic acids of general formula (II) include hydroxy butyric acid, hydroxy valeric acid, hydroxy caproic acid, hydroxy caprylic acid, hydroxy pelargonic acid, hydroxy capric acid, hydroxy lauric acid, hydroxy mytistic acid, hydroxy palmitic acid, hydroxy margaric acid, hydroxy stearic acid, hydroxy arachidic acid, hydroxy behenic acid, hydroxy lignoceric acid, hydroxy cerotic acid, hydroxy carboceric acid, hydroxy montanic acid, hydroxy melissic acid, hydroxy lacceroic acid, hydroxy ceromelissic acid, hydroxy geddic acid, hydroxy ceroplastic acid, hydroxy obtusilic acid, hydroxy caproleic acid, hydroxy lauroleic acid, hydroxy linderic acid, hydroxy myristoleic acid, hydroxy physeteric acid, hydroxy tsuzuic acid, hydroxy pahnitoleic acid, hydroxy sapienic acid, hydroxy petroselinic acid, hydroxy oleic acid, hydroxy elaidic acid, hydroxy vaccenic acid, hydroxy gadoleic acid, hydroxy gondoic acid, hydroxy cetoleic acid, hydroxy erucic acid, hydroxy nervonic acid, hydroxy linoleic acid, hydroxy γ-linolenic acid, hydroxy dihomo-γ-linolenic acid, hydroxy arachidonic acid, hydroxy linolenic acid, hydroxy steridonic acid, hydroxy nisinic acid, and hydroxy Mead Acid.

Other examples of hydroxycarboxylic acids that may undergo cyclic condensation to form cyclic esters suitable for use in accordance with the invention include 3-hydroxypropanoic acid, 4-hydroxybutanoic acid, 4-hydroxypentanoic acid, 4-hydroxyhexanoic acid, 4-hydroxyheptanoic acid, 4-hydroxyoctanoic acid, 4-hydroxy-4-methylpentanoic acid, 4-hydroxy-4-methylhexanoic acid, 4-hydroxy-4-ethylhexanoic acid, 4-hydroxy-4-methylheptanoic acid, 4-hydroxy-4-ethylheptanoic acid, 4-hydroxy-4-propylheptanoic acid, 4-hydroxy-4-methyloctanoic acid, 4-hydroxy-4-ethyloctanoic acid, 4-hydroxy-4-propyloctanoic acid, 4-hydroxy-4-butyloctanoic acid, 5-hydroxypentanoic acid, 5-hydroxyhexanoic acid, 5-hydroxyheptanoic acid, 5-hydroxyoctanoic acid, 5-hydroxy-5-methylhexanoic acid, 5-hydroxy-5-methylheptanoic acid, 5-hydroxy-5-ethylheptanoic acid, 5-hydroxy-5-methyloctanoic acid, 5-hydroxy-5-ethyloctanoic acid, 5-hydroxy-5-propyloctanoic acid, 6-hydroxyhexanoic acid, 6-hydroxyheptanoic acid, 6-hydroxyoctanoic acid, 6-hydroxy-6-methylheptanoic acid, 6-hydroxy-6-methyloctanoic acid, 6-hydroxy-6-ethyloctanoic acid, 7-hydroxyheptanoic acid, 7-hydroxyoctanoic acid, 7-hydroxy-7-methyloctanoic acid, 8-hydroxyoctanoic acid, and other aliphatic hydroxycarboxylic acids.

Reagents, equipment, and conditions for manufacturing cyclic esters through the cyclic condensation of hydroxycarboxylic acids are generally well known in the art. Cyclic esters suitable for use in accordance with the invention can advantageously be prepared in a similar manner. For example, cyclic esters can be prepared using several methods described in the literature. (Journal of Biomedical Materials Research Part A, Volume 80A, Issue 1, pp 55-65, Polymer Preprints 2005, 46 (2), 1040, Polymer Preprints 2005 (46 (2), 1006).

In accordance with the invention, an aliphatic condensation polymer is melt mixed with a cyclic ester of general formula (I). Melt mixing can be performed using methods well known in the art. For example, melt mixing may be achieved using continuous extrusion equipment such as twin screw extruders, single screw extruders, other multiple screw extruders and Farell mixers. Semi-continuous or batch processing equipment may also be used to achieve melt mixing. Examples of such equipment include injection moulders, Banbury mixers and batch mixers. Static melt mixing equipment may also be used.

By melt mixing the aliphatic condensation polymer and the cyclic ester, it has been found that the cyclic ester can undergo reaction with the condensation polymer so as to incorporate the ring opened form of the cyclic ester as part of the condensation polymer backbone. The polymer composition may also comprise a proportion of the cyclic ester that has not undergone reaction with the aliphatic condensation polymer and/or polymer that has formed through ring opening polymerisation of the cyclic ester.

Those skilled in the art will appreciate that by the ring opened form of the cyclic ester being “incorporated” as part of the polymer backbone of the aliphatic condensation polymer is meant that the cyclic ester ring opens and becomes covalently bound to and form part of the polymer backbone. Without wishing to be limited by theory, it is believed that this process at least involves the ring opened cyclic ester being covalently bound to a terminal end of the polymer backbone, possibly followed by inter and/or intra polymer chain rearrangement of the ring opened cyclic ester such that it becomes located at a non-terminal position within the polymer backbone (e.g. through a transesterification process). In other words, although the ring opened form of the cyclic ester may initially attach to a terminal section of the aliphatic condensation polymer, it may nevertheless rearrange its position within the polymer backbone through a transesterification process.

For example, an aliphatic condensation polymer modified with a cyclic ester of general formula (I) in accordance with the invention may comprise within its polymer backbone the ring opened residue of the cyclic ester as illustrated below in Scheme 1. The modified polymer will of course generally comprise within its polymer backbone a number of such ring opened residues.

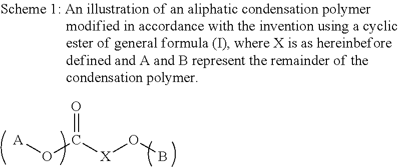

With the reference to Scheme 1, the aliphatic condensation polymer can be seen to comprise the ring opened residue of the cyclic ester as part of its polymer backbone (i.e. the moiety not within parenthesis). The ring opened residue of the cyclic ester itself can be seen to be formed from a condensed residue of the hydroxycarboxylic acid of general formula (II).

Accordingly, the modified condensation polymer may be described as comprising hydroxycarboxylic acid residue within its polymer backbone.

The hydroxycarboxylic acid residue that forms part of the polymer backbone of the modified condensation polymer is believed to modify the properties of the polymer. In particular, depending upon the nature of the aliphatic hydrocarbon group X, the hydroxycarboxylic acid residue can in effect extend the chain length of the polymer backbone by the number of carbon atoms that form part of the cycle of the cyclic ester, and may also introduce a pendant hydrocarbon chain to the polymer backbone derived from a portion of the hydrocarbon chain that does not form part of the cycle of the cyclic ester. Without wishing to be limited by theory, it is believed that this “in-chain” extension of, and any pendant chain addition to, the polymer backbone gives rise to the modified properties of the condensation polymer.

For example, aliphatic polyesters (e.g. polylactic acid, polyhydroxybuterate, and polybutylene succinate adipate) modified with cyclic esters of general formula (I) (e.g. caprolactone) in accordance with the invention have been shown to exhibit improved flexibility and softness and in some cases increased tear resistance.

Those skilled in the art will appreciate that the cyclic ester of general formula (I) will be selected so as to impart new and/or improved properties to the modified condensation polymer. Accordingly, there would generally be no practical use in selecting for example caprolactone as a cyclic ester to modify polycaprolactone.

A condensation catalyst may also be employed in order to enhance the melt reaction between the aliphatic condensation polymer and the cyclic ester. Typical condensation catalysts include Lewis acids such as antimony trioxide, titanium oxide and dibutyl tindilaurate.

Melt mixing of the aliphatic condensation polymer and the cyclic ester may also be conducted in the presence of one or more additives such as fillers, pigments, stabilisers, blowing agents, nucleating agents, and chain coupling and/or branching agents.

Chain coupling and/or branching agents may be used in accordance with the invention to promote an increase in the molecular weight of and/or chain branching in the resulting modified aliphatic condensation polymer. Such agents include polyfunctional acid anhydrides, epoxy compounds, oxazoline derivatives, oxazolinone derivatives, lactams and related species.

Suitable chain coupling and/or branching agents include one or more of the following:

Polyepoxides such as bis(3,4-epoxycyclohexylmethyl) adipate; N,N-diglycidyl benzamide (and related diepoxies); N,N-diglycidyl aniline and derivatives; N,N-diglycidylhydantoin, uracil, barbituric acid or isocyanuric acid derivatives; N,N-diglycidyl diimides; N,N-diglycidyl imidazolones; epoxy novolaks; phenyl glycidyl ether; diethyleneglycol diglycidyl ether; Epikote 815 (diglycidyl ether of bisphenol A-epichlorohydrin oligomer).

Polyoxazolines/Polyoxazolones such as 2,2-bis(2-oxazoline); 1,3-phenylene bis(2-oxazoline-2), 1,2-bis(2-oxazolinyl-2)ethane; 2-phenyl-1,3-oxazoline; 2,2′-bis(5,6-dihydro-4H-1,3-oxazoline); N,N′-hexamethylenebis (carbamoyl-2-oxazoline; bis[5(4H)-oxazolone); bis(4H-3,1-benzoxazin-4-one); 2,2′-bis(H-3,1-benzozin-4-one).

Polyfunctional acid anhydrides such as pyromellitic dianhydride, benzophenonetetracarboxylic acid dianhydride, cyclopentanetetracarboxylic dianhydride, diphenyl sulphone tetracarboxylic dianhydride, 5-(2,5-dioxotetrahydro-3-furanyl)-3-methyl-3-cyclohexene-1,2-dicarboxylic dianhydride, bis(3,4-dicarboxyphenyl)ether dianhydride, bis(3,4-dicarboxyphenyl)thioether dianhydride, bisphenol-A bisether dianhydride, 2,2-bis(3,4-dicarboxyphenyl)hexafluoropropane dianhydride, 2,3,6,7-naphthalenetetracarboxylic acid dianhydride, bis(3,4-dicarboxyphenyl)sulphone dianhydride, 1,2,5,6-naphthalenetetracarboxylic acid dianhydride, 2,2′,3,3′-biphenyltetracarboxylic acid, hydroquinone bisether dianhydride, 3,4,9,10-perylene tetracarboxylic acid dianhydride, 1,2,3,4-cyclobutanetetracarboxylic acid dianhydride, 3,4-dicarboxy-1,2,3,4-tetrahydro-lnaphthalene-succinic acid dianhydride, bicyclo(2,2)oct-7-ene-2,3,5,6-tetracarboxylic acid dianhydride, tetrahydrofuran-2,3,4,5-tetracarboxylic acid dianhydride, 2,2-bis(3,4dicarboxyphenyl)propane dianhydride, 3,3′,4,4′-biphenyltetracarboxylic acid dianhydride, 4,4′-oxydiphthalic dianhydride (ODPA), and ethylenediamine tetraacetic acid dianhydride (EDTAh).

It is also possible to use acid anhydride containing polymers or copolymers as the acid anhydride component.

Suitable polyfunctional acid anhydrides include pyromellitic dianhydride, 1,2,3,4-cyclopentanetetracarboxylic acid dianhydride, 1,2,3,4-cyclobutanetetracarboxylic acid dianhydride and tetrahydrofuran-2,3,4,5-tetracarboxylic acid dianhydride. Most preferably the polyfunctional acid anhydride is pyromellitic dianhydride.

Polyacyllactams such as N,N′-terephthaloylbis(caprolactarn) and N,N′-terephthaloylbis(laurolactam) may also be employed.

The polymer composition resulting from the methods of the invention may also be subjected to a subsequent solid state condensation polymerisation process. This further processing step can assist with building the molecular weight of the modified aliphatic condensation polymer and can advantageously be conducted using conventional solid state condensation polymerisation techniques and equipment.

When performing the methods of the invention, it may be convenient to provide the cyclic ester, optionally together with any other additives that are to be used, in the form of a composition that can be used for producing the modified aliphatic condensation polymer. This composition may be provided in the form of a physical blend of the respective components and/or in the form a melt processed product.

The invention therefore also provides a composition for modifying aliphatic condensation polymer, the composition comprising one or more carrier polymers and a cyclic ester of general formula (I), and/or a melt mixed product of one or more carrier polymers and a cyclic ester of general formula (I).

The carrier polymer may in fact be the aliphatic condensation polymer that is to be modified in accordance with the invention. In that case the composition may simplistically be a physical blend of the cyclic ester and the polymer, and the method of the invention is preformed by melt mixing that composition.

It may also be desirable to provide at least the cyclic ester in the form of a masterbatch or concentrate which can be subsequently melt mixed with an aliphatic condensation polymer that is to be modified in accordance with the invention.

As used herein, the term “masterbatch” or “concentrate” (to be used synonymously herein) has the common meaning as would be understood by one skilled in the art. With particular reference to the present invention, these terms are therefore intended to mean a composition comprising the cyclic ester and one or more carrier polymers, which composition is to be subsequently let down in an aliphatic condensation polymer in order to perform the methods of the invention.

The masterbatch may be formed by melt mixing the cyclic ester with a carrier polymer that is considered appropriate under the circumstance to be melt mixed with the aliphatic condensation polymer that is to be modified. The carrier polymer may be an aliphatic condensation polymer, for example an aliphatic condensation polymer of the same type as the one that is to be modified.

Where the carrier polymer is an aliphatic condensation polymer, it will be appreciated that the process of making the masterbatch in effect employs the method of the invention. However, by qualifying the product a “masterbatch”, it will also be appreciated that the intention is for the masterbatch to be employed in performing the methods of the invention. In other words, it is the intention that the masterbatch will comprise unreacted cyclic ester that can be subsequently melt mixed with an aliphatic condensation polymer so as to perform the methods of the invention.

A masterbatch formed by melt mixing the cyclic ester with an aliphatic condensation polymer may itself comprise aliphatic condensation polymer that has been modified in accordance with the invention. Melt mixing this modified aliphatic condensation polymer per se with further aliphatic condensation polymer (as will be the case when the masterbatch is melt mixed with an aliphatic condensation polymer) can itself result in the further aliphatic condensation polymer being modified as described herein (e.g. in the case of polyesters, through transesterification reactions).

Aliphatic condensation polymers that may be used as a carrier polymer in the compositions of the invention include those described herein.

Preparing a masterbatch by melt mixing the cyclic ester with an aliphatic condensation polymer and then subsequently melt mixing the masterbatch with an aliphatic condensation polymer is believed to provide a more efficient and effective means of incorporating the ring opened residues as part of the polymeric backbone of the aliphatic condensation polymer.

Those skilled in the art will appreciate that the appropriate temperature at which a given polymer is to be melt mixed with the cyclic ester will vary depending on the type of polymer being employed. Generally, melt mixing of the cyclic ester and the aliphatic condensation polymers will be conducted at a temperature ranging from about 120° C. to about 240° C.

Provided that the properties of the aliphatic condensation polymer is modified in at least some way, there is no particular limitation on the amount of cyclic ester that is to be melt mixed with the aliphatic condensation polymer. However, the cyclic ester will generally be used in an amount ranging from about 5 wt. % to about 35 wt. %, preferably 5 wt. % to about 20 wt. %, relative to the total mass of the cyclic ester and the aliphatic condensation polymer.

Where the cyclic ester is combined with one or more carrier polymers to form a masterbatch, the cyclic ester will generally be used in an amount ranging from about 30 wt. % to about 80 wt. %, relative to the total mass of the cyclic ester and the one or more carrier polymers.

Cyclic esters used in accordance with the methods of the invention can impart to the resulting modified aliphatic condensation polymer properties such as improved flexibility, an alteration in its hardness (either decreased through the incorporation of softer segments provided by the X group, or increased through crosslinking induced from reaction of functional groups within or pendant from the X group), an alteration in its surface properties (e.g. hydrophobicity provided by the X group), altered degradation rates (either decreased through making the polymer overall more hydrophobic (e.g. hydrophobicity provided by the X group) and so less prone to hydrolytic attack, or increased through the introduction via the X group of hydrolytically liable groups to a relatively stable polymer), an alteration in its stiffness (either decreased through the X group breaking up crystallininty, or increased through crosslinking induced from reaction of functional groups within or pendant from the X group), and improved melt viscosity or melt strength resulting directly from the presence of the X group, or through long chain branching induced from reaction of functional groups within or pendant from the X group and the base polymer.

Using the methods of the invention, an aliphatic condensation polymer may also be converted into a thermoset polymer via reaction of functional groups within or pendant from the X group (e.g. oxidative crosslinking of a coating product produced from the modified polymer, or crosslinking reactions where the modified condensation polymer is included in the formulation of a thermoset resin such as a unsaturated polyester, vinyl ester resin, epoxy resin etc).

The stability (e.g. UV) or colour fastness of a modified aliphatic condensation polymer prepared in accordance with the invention may also be improved by tethering an appropriate moiety to the X group (e.g. moieties such as stabilises (e.g. hindered phenols and hindered amine light stabilisers), alkoxy amines, dyes, and bioactive materials).

The modified condensation polymers of this invention can be utilised in products ranging from: films for packaging applications, injection moulded articles, blow moulded containers, sheet products, thermoformed products, coatings, adhesives, fibres, scaffolds for medical applications including tissue repair and drug delivery.

The present invention will hereinafter be further described with reference to the following non-limiting examples.

### EXAMPLES

### General

Proton NMR spectra were obtained on Bruker AV400 and Bruker AV200 spectrometer, operating at 400 MHz and 200 MHz. All spectra were obtained at 23° C. unless specified. Chemical shifts are reported in parts per million (ppm) on the δ scale and relative to the chloroform peak at 7.26 ppm (¹H) or the TMS peak at 0.00 ppm (¹H). Oven dried glassware was used in all reactions carried out under an inert atmosphere (either dry nitrogen or argon). All starting materials and reagents were obtained commercially unless otherwise stated. Removal of solvents “under reduced pressure” refers to the process of bulk solvent removal by rotary evaporation (low vacuum pump) followed by application of high vacuum pump (oil pump) for a minimum of 30 min. Analytical thin layer chromatography (TLC) was performed on plastic-backed Merck Kieselgel KG60F₂₅₄ silica plates and visualised using short wave ultraviolet light, potassium permanganate or phosphomolybdate dip. Flash chromatography was performed using 230-400 mesh Merck Silica Gel 60 following established guidelines under positive pressure. Tetrahydrofuran and dichloromethane were obtained from a solvent dispensing system under an inert atmosphere. All other reagents and solvents were used as purchased.

### Monomer Synthesis and Characterisation

### Generic Procedure for the Lactonisation of Omega Hydroxyl Fatty Acids

Synthesis of Hexadecanolide from 15-Hydroxypentadecanoic Acid

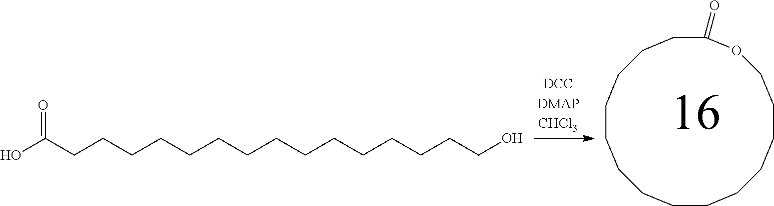

A flame-dried 50 ml round bottomed flas, equipped with stirring bar, reflux condenser with serum cap, argon inlet (through serum cap), and syringe pump inlet (vide infra, through serum cap), was charged with 25 ml of ethanol free chloroform, 0.343 g (1.66 mmol) of DCC, 0.305 g (2.50 mmol) of 4-(dimethylamino)pyridine and 0.263 g (1.66 mmol) of 4-(dimethylamino)pyridine hydrochloride. The resulting solution was brought to reflux, and a solution of 0.215 g (0.832 mmol) of 15-hydroxypentadecanoic acid in 5.0 ml of THF was infused via syringe pump over 16 h. (A Glenco gas tight syringe with a Teflon seal and Teflon tubing was utilized, and the inlet of the Teflon tubing was positioned in the condensate formed at the tip of the reflux condenser.) After addition was completed, the syringe apparatus was removed and the reaction mixture was cooled to room temperature. The residual contents of the syringe and the Teflon tubing were rinsed into a tared flask and concentrated to afford 11.5 mg of starting hydroxyl acid. Methanol (1.0 ml) and acetic acid (0.19 ml, 4.0 equiv.) were added to the reaction flask and stirring was continued for 30 min, at which time no DCC was detected by TLC analysis (10% EtOAc-hexanes). Further TLC-analysis in two solvent systems revealed the formation of the desired lactone (Rf 0.32 in 10% EtOAc-hexanes), N-acylurea (independently prepared, Rf 0.32 in 35% THF-hexanes) was not detected. The mixture was concentrated to 5 ml, diluted with 25 ml of ether, filtered, and concentrated. The residue was taken up in a minimal amount of chloroform and applied to a 24×1.5 cm column of silica gel (Davisil 60-200 mesh) slurry packed in hexanes. Elution was with 20 ml of hexanes and then with 3% THF-hexanes; 6 ml fractions were collected. Concentration of fractions 11-13 gave 0.180 g (95%, based on hydroxyl acid delivered to the reaction vessel) of hexadecanolide, identical in all respects with an authentic sample.

### Polymers Used for Melt Mixing

The following polymers were used to produce the examples for melt mixing with the lactones:

PLA=Polylactic acid—Natureworks 3051D, supplied by Cargill, USA

Nylon 11=Rilsan BESNO TL (Check?), supplied by Arkema, France

PHB=Poly 3 hydroxy butyrate—Biomer 229, Biomer Germany

PBSA=polybutylene co succinic acid/adipic acid—Bionolle, Showa, Japan

### Commercial Lactones Used

Caprolactone—Sigma Aldrich [CL]

Omega Pentadecalactone—SAFS Solutions, USA [C15L]

### Catalyst

Tin (II) 2 Ethyl Hexanoate, supplied by Sigma Aldrich

Dibutyl Tin Dilaurate (DBTDL), supplied by Sigma Aldrich

### Method for Melt Mixing

(A) Twin Screw Extruder—Liquid injection of Lactone. [EL]

Melt mixing reactions were carried out in a Thermo Prism 16 mm twin screw extruder having a L/D of 40:1 fitted with segmented screws and individually heated barrel segments (see Scheme 2).

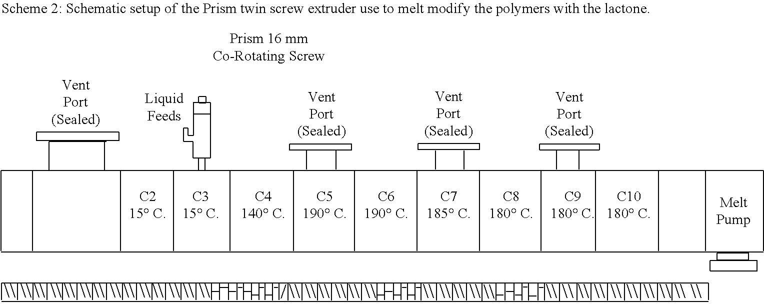

The lactone monomer was dried under vacuum at 80 C with stirring. The lactone was mixed with 0.1 wt % of the liquid catalyst and then charged into the barrel of an ISCO 500D syringe pump fitted with a transfer line to dispense the lactone into the barrel of the twin screw extruder. Both the syringe pump and transfer line were heated to 80 C when the cyclic lactone was not a free flowing liquid at ambient temperature (eg C15 Lactone).

The gravimetric output of the ISCO syringe pump was calibrated at a number of relevant volumetric throughput rates prior to connecting to the extruder.

The polymer was dried in a small scale hopper drier using dry air at temperatures according to the manufacturer's recommendations. All samples were dried to <100 ppm water, as measured using an Arizona Instruments moisture analyser.

The dried polymer was fed to the extruder via a Barrell single screw volumetric feeder. The feeder and extruder hopper were flushed with dry air to prevent moisture ingress. The gravimetric output of the feeder and extruder were monitored by collecting samples before and after collecting samples.

The extruder was fitted with a 1 mm rod die and operated at a throughput of rate of approximately 25 g/hour. The exact throughput rate was determined for each sample.

The extruded samples which were subsequently melt pressed were collected in sample jars purged with dry nitrogen. Melt pressing was carried in an IHMS melt press (250 by 250 mm plattern) fitted with brass plates through water could be passed to cool the sample after pressing. Samples were pressed between Teflon sheets. A 150 by 150 by 0.150 mm shim plate was used for the melt pressing.

Extruded strand samples were also collected for each composition.

(B) Melt Mixing in Round Bottom Flasks—Method with Overhead Stirring [RBF]

Polymers were dried using the same methodology as was used for the extrusion samples. The lactone samples were vacuum dried prior to use.

The 100 ml round bottom flasks used for the experiments were cleaned and dried in an oven set at 80 C. Upon removal from the oven the flasks were stoppered and allowed to cool. Upon opening the flasks to add the reagents, the flasks were flushed with dry nitrogen. The flasks were then fitted with metal stirrers having two blades. The stirrers were connected to overhead drive motors. The stirrers were held in place by a glass adapter fitted with a Teflon bearing fitted with a rubber seal. The glass adaptor was also fitted with a water cooled Leibig condenser and a separate nitrogen inlet to prevent moisture ingress.

Approximately 20 g of the selected polymer was added to each flask, the required amount of lactone and 20 drops of DBTDL catalyst.

The flasks fitted with the adaptors, condensors and stirrers were then placed in a silicone oil bath on top of a magnetic stirrer hotplate. The oil temperature was controlled to the desired temperature (200 C for PLA, 250 C for Nylon 11) and monitored via a calibrated thermometer.

Samples were allowed to heat and stir for times up to 240 min. The rate of stirring was set between 100 to 200 rpm. The exact rate adjusted to give good mixing to best provide the incorporation of the lactone modifier.

At the completion of the reaction the stirrers and condensors were removed and samples were poured from the flasks under a blanket of dry nitrogen. The samples were then allowed to cool. For melt pressing samples were reheated in a vacuum oven, subsamples were removed for analysis from the flasks and were melt pressed using the same procedure as was used for the extrusion samples.

### Characterisation of Polymers

Polymer samples were characterised by a number of techniques as described below.

### NMR—Nuclear Magnetic Resonance

Proton NMR spectra were obtained on Bruker AV400 and Bruker AV200 spectrometer, operating at 400 MHz and 200 MHz. All spectra were obtained at 23° C. unless specified. Chemical shifts are reported in parts per million (ppm) on the δ scale and relative to the chloroform peak at 7.26 ppm (¹H) or the TMS peak at 0.00 ppm (¹H).

### GPC—Gel Permeation Chromatography

Molecular weights of polymer were characterized by gel permeation chromatography (GPC) performed in tetrahydrofuran (1.0 mL/min) at 25° C. using a Waters GPC instrument, with a Waters 2414 Refractive Index Detector, a series of four Polymer Laboratories PLGel columns (3×5 μm Mixed-C and 1×3 μm Mixed-E), and Millennium Software. The GPC was calibrated with narrow polydispersity polystyrene standards (Polymer Laboratories EasiCal, MW from 264 to 256000), and molecular weights are reported as polystyrene equivalents.

—20 mg samples were dissolved in 2 mL of THF, were filtered through a 0.2 um Teflon filter into a sample vial fitted with a septum.

### DSC—Differential Scanning Calorimetry

The thermal transitions were characterized using a Mettler Toledo DSC 21^{e} Differential Scanning calorimeter. Approximately 10 milligram sample was weighed and ran the scan cycle under nitrogen. For each experiment, the temperature was equilibrated at room temperature for several minutes before the scan cycle starts. The heating and cooling rate was kept constant at 10° C./minute. At first the sample was cooled down to −50° C., then heated to 200° C. followed by cooling down to −60° C. and subsequently heated again up to 300° C.

### Tensile Testing

Tensile testing was carried out using an Instron 5500R machine. Melt pressed film samples were cut into tensile bars (Length=31.5 mm, Width=4.2 mm, Gauge length=15 mm) using a compression cutter. Samples were conditioned in a controlled temperature and humidity room for 48 hours prior to testing. Samples were tested according to ASTM 882 at a crosshead speed of 7.5 mm/min for the PLA and Bionolle samples. For the Nylon 11 samples a crosshead speed of 150 mm/min was used.

### Modified Polymers

| | | | Modifier | |
|---|---|---|---|---|
| Example | Polymer | Modifer | Wt % | Method |
| 1 | PLA | CL | 5 | EL |
| 2 | PLA | CL | 10 | EL |
| 3 | PLA | CL | 15 | EL |
| 4 | PLA | CL | 20 | EL |
| 5 | PLA | CL | 25 | EL |
| 6 | PLA | CL | 33 | EL |
| 7 | PLA | CL | 50 | EL |
| 8 | PLA | CL | 66 | EL |
| 9 | PLA | CL | 80+ | EL |
| 10 | Bionolle | CL | 5 | EL |
| 11 | Bionolle | CL | 10 | EL |
| 12 | Bionolle | CL | 15 | EL |
| 13 | Bionolle | CL | 20 | EL |
| 14 | Bionolle | CL | 33 | EL |
| 15 | Bionolle | CL | 50 | EL |
| 16 | N 11 | CL | 0 | EL |
| 17 | N 11 | CL | 5 | EL |
| 18 | N 11 | CL | 10 | EL |
| 19 | N 11 | CL | 15 | EL |
| 20 | N 11 | CL | 20 | EL |
| 21 | N 11 | CL | 30 | EL |
| 22 | N 11 | CL | 40 | EL |
| 23 | N 11 | CL | 50 | EL |
| 24 | PLA | CL | 3.9 | RBF |
| 25 | PLA | CL | 7.7 | RBF |
| 26 | PLA | CL | 11.4 | RBF |
| 27 | PLA | CL | 15.0 | RBF |
| 28 | PLA | CL | 20.0 | RBF |
| 29 | PLA | CL | 21.9 | RBF |
| 29b | PLA | CL | 45.4 | RBF |
| 29c | PLA | CL | 22.7 | RBF2 |
| 30 | PLA | C15 | 7.90 | RUFF |
| 31 | PLA | C15 | 14.95 | RUFF |
| 32 | PLA | C15 | 21.3 | RUFF |
| 33 | PLA | C15 | 27.05 | RUFF |
| 34 | PLA | C15 | 37.05 | RUFF |

### Analysis

### NMR

NMR Analysis for Reaction of Caprolactone with Polylactic was carried out using the method for analysing the reaction product of Caprolactone with D,L Lactide as described in Makromol. Chem. 194, 2463-2469 (1993)

Conversion of wt % into mol %:

Mol % (CL)=wt % (CL)/114.14 g/mol/[wt % (CL)/114.14 g/mol+wt % (LA)/72.00 g/mol]

Conversion of mol % into wt %:

Weight % (CL)=mol % (CL)×114.14 g/mol/[mol % (CL)×114.14 g/mol+mol % (LA)×72.00 g/mol

CL=caprolactone

LA=lactic acid

114.14=molecular weight of CL

72.00=molecular unit weight of LA

Mol % (CL) from NMR (chloroform):

Mol % (CL)=Integral between 4.30 ppm and 3.95 ppm (CL)/[2×(integral between 5.30 ppm and 5.00 ppm) (LA)+Integral between 4.30 ppm and 3.95 ppm (CL)

### Examples Obtained Through Extruder Modification Method (EL)

| | wt % | wt % | | wt % | wt % | wt % CL | wt % |
|---|---|---|---|---|---|---|---|
| | (mol %) | (mol %) CL | mol % | (mol %) | (mol %) | connect to | (mol %) CL |
| Example | CL feed | from NMR | CL-LA | CL-CL | unreacted CL | lactic acid | as polymer |
| 1 | 5.0 (3.2) | 3.4 (2.2) | 0.02 | 0.5 (0.3) | 3.0 (1.9) | 0.03 | 0.53 (0.32) |
| 2 | 10.0 (6.6) | 5.3 (3.4) | 0.01 | 0.8 (0.5) | 4.5 (2.9) | 0.02 | 0.82 (0.51) |
| 3 | 15.0 (10.0) | 8.9 (5.8) | 0.2 | 1.9 (1.2) | 6.8 (4.4) | 0.3 | 2.2 (1.4) |
| 4 | 20.0 (13.6) | 12.3 (8.1) | 0.4 | 3.9 (2.5) | 8.0 (5.2) | 0.6 | 4.5 (2.9) |
| 5 | 25 (17.4) | 15.7 (10.5) | 0.7 | 6.0 (3.9) | 9.0 (5.9) | 1.1 | 7.1 (4.6) |
| 6 | 33 (23.7) | 17.1 (11.5) | 0.9 | 7.4 (4.8) | 8.9 (5.8) | 1.4 | 8.8 (5.7) |
| 7 | 50 (38.7) | 32.3 (23.1) | 1.8 | 20.2 (13.8) | 11.4 (7.5) | 2.8 | 23.0 (15.6) |
| 8 | 66 (55.1) | 41.0 (30.5) | 2.3 | 29.0 (20.5) | 11.7 (7.7) | 3.6 | 32.6 (22.8) |
| 9 | 80+ (72.6+) | 49.8 (38.5) | 3.2 | 36.0 (26.2) | 13.7 (9.1) | 5.0 | 41.0 (35.3) |

### Examples Obtained Through Batch Melt Mixing Method (RBF)

| | | Wt % | | | wt % | wt % |
|---|---|---|---|---|---|---|
| | wt % | (mol %) | wt % | wt % | (mol %) | (mol %) |
| Exam- | (mol %) | CL from | (mol %) | (mol %) | unreacted | CL as |
| ple | CL feed | NMR | CL-LA | CL-CL | CL | polymer |
| 24 | 3.9 (2.5) | 10.6 | 9.3 | 1.3 | 0 | 10.6 |
| 25 | 7.7 (5.0) | 3.9 | 2.9 | 1.0 | 0.04 | 3.9 |
| 26 | 11.4 (7.5) | 7.4 | 3.1 | 4.2 | 0 | 7.3 |
| 27 | 15.0 (10.0) | 29.1 | 15.7 | 13.4 | 0 | 29.1 |
| 28 | 20.0 (13.6) | 11.1 | 3.1 | 6.7 | 1.3 | 9.8 |
| 29 | 21.9 (15.0) | 11.4 | 9.5 | 1.8 | 0.1 | 11.3 |

### Masterbatch Examples

As an example of demonstrating that the modified material can be used as a masterbatch, a amount of the modified polymer (Example 29b), was dried and was melt mixed with as an equal wt:wt basis with PLA pellets using the method RBF-2.

| | | Wt % | | | wt % | wt % |
|---|---|---|---|---|---|---|
| | wt % | (mol %) | wt % | wt % | (mol %) | (mol %) |
| | (mol %) | CL from | (mol %) | (mol %) | unreacted | CL as |
| Example | CL feed | NMR | CL-LA | CL-CL | CL | polymer |
| 29c | 22.7 (15.0) | 12.1 | 2.9 | 5.2 | 0.7 | 8.3 |

### GPC Analysis of Selected Samples

| Example | Composition | Mn | Mw | Mp | PD |
|---|---|---|---|---|---|
| Control-1 | PLA Pellet | | | | |
| Control-2 | PLA + catalyst | 41989 | 70302 | 73559 | 1.67 |
| | Method = (RBF) | | | | |
| 24 | 2.5 mol % e-Cap | 42642 | 74163 | 76948 | 1.74 |
| 25 | 5 mol % e-Cap | 37145 | 62262 | 68474 | 1.68 |
| 26 | 7.5 mol % e-Cap | 40234 | 64526 | 70405 | 1.60 |
| 27 | 10 mol % e-Cap | 32532 | 54876 | 49651 | 1.69 |
| 28 | 13.6 mol % e-Cap | 62859 | 98032 | 93777 | 1.56 |
| 29 | 15.0 mol % e-Cap | 20761 | 35372 | 37347 | 1.70 |
| Comparative | 100% e-Cap | 41640 | 68376 | 70884 | 1.64 |
| Example 1 | | | | | |

| | mol % | | | | |
|---|---|---|---|---|---|
| Example | C15 feed | Mn | Mw | Mp | PD |
| Control-1 | | | | | |
| 30 | 2.5 | | | | |
| 31 | 5 | 57000 | 95681 | 80559 | 1.68 |
| 32 | 7.5 | 65448 | 106636 | 83269 | 1.63 |
| 33 | 10 | 55515 | 86104 | 77258 | 1.55 |
| 34 | 15 | | | | |
| Comparative | 100 | | | | |
| Example | | | | | |

| | | Melting | | | | |
|---|---|---|---|---|---|---|
| | | Peak 1 # | | Melting | | |
| | | Temps | Melting | Peak 2 # b | | |
| | | (C) | Peak 1 | Temps (° C.) | Melting | |
| | | Start-S | # | Start-S | Peak 2# | |
| | | Peak-P | Energy | Peak-P | Energy | |
| Example | Composition | End-E | (J/g) | End-E | (J/g) | Comments |
| Control-1 | PLA α | — | — | S-96 | 38 | No lactide |
| | (60 min) | — | | P-130, 144 | | residue as |
| | | — | | E-156 | | Peak 1. |
| | | — | | | | Peak 2: |
| | | | | | | double |
| | | | | | | melting peak |
| Control-2 | PLA α | S-48 | 1.01 | S-116 | 27 | Lactide |
| | (80 min) | P-50 | | P140, 151 | | residue as |
| | | E-62 | | E-161 | | Peak 1 |
| 24 | 2.5 mol % CL | S-37 | | S-95 | 31 | Lactide |
| | | P-48 | | P140, 149 | | residue as |
| | | E-56 | 1.8 | E-160 | | Peak 1 |
| 25 | 5 mol % CL | | | S-118 | 25 | Peak 1- |
| | | S-38 | | P-148 | | appears to |
| | | P-53 | | E-157 | | have lactide |
| | | E-80 | 9.3 | | | and PCL |
| 26 | 7.5 mol % CL | S-45 | | S-93 | 17 | |
| | | P-56 | | P-141 | | |
| | | E-65 | 0.5 | E-147 | | |
| 27 | 10 mol % CL | S-32 | | S-93 | 21 | Peak 2: |
| | | P-44 | | P-138, 147 | | double |
| | | E-57 | 0.6 | E-158 | | melting peak |
| 29 | 15 mol % CL | S-41 | | S-112 | 33 | Peak 2: |
| | | P-46 | | P-138, 145 | | double |
| | | E-54 | 0.09 | E-159 | | melting peak |
| Comp Ex 1 | 100 mol % CL | S-34 | | | | |
| | | P-65 | | | | |
| | | E-77 | 103 | | | |
| 30 | 2.5 mol % C15 | | | S-93 | 38 | Peak 2: |
| | | | | P-137, 149 | | double |
| | | | | E-171 | | melting peak |
| 31 | 5 mol % C15 | S-31 | | S-90 | 26 | Peak 2: |
| | | P-50 | | P-132, 142 | | double |
| | | E-64 | 0.5 | E-151 | | melting peak |
| 32 | 7.5 mol % C15 | | | S-109 | 21 | Strong |
| | | | | P-132, 139 | | crystallisation |
| | | | | E-150 | | peak |
| 33 | 10 mol % C15 | | | S-97 | 21 | Strong |
| | | | | P-122, 136 | | crystallisation |
| | | | | E-150 | | peak |
| 34 | 15 mol % C15 | | | S-104 | 20 | Strong |
| | | | | P-131, 136 | | crystallisation |
| | | | | E-148 | | peak |
| Comp Ex 2 | 100 mol % C15 | | | S-53 | 55 | |
| | | | | P-83 | | |
| | | | | E-95 | | |

# DSC data taken from first heat cycle of sample
a-PLA and Nylon 11 controls are for samples which have been melt mixed under the same conditions. Times represent melt mixing times.
b-Major peak in bold

### =TENSILE

| | | | | | | |
|---|---|---|---|---|---|---|
| | % Elon- | Load | Stress | Elon- | Load | Youngs |
| | gation | at | at | gation | at | Modulus |
| | At Max | Max | Max | At Break | Break | 3-5% |
| Example | Load | (N) | (MPa) | (%) | (N) | (MPa) |

PLA

| | | | | | | |
|---|---|---|---|---|---|---|
| Control | 7.3 | 31.7 | 55.0 | 11.2 | 24.1 | 1320 |
| PLA | SD1.4 | SD 2.2 | SD 2.6 | SD 5.3 | SD 7.6 | SD 150 |
| 1 | 7.1 | 35.6 | 45.8 | 7.5 | 33.5 | 1324 |
| | SD 1.0 | SD 6.7 | SD 7.4 | SD 08 | SD 5.2 | SD 341 |
| 2 | 3.9 | 36.2 | 37.3 | 5.9 | 36.2 | 1272 |
| | SD 3 | SD 10 | SD 10 | SD 2 | SD 10 | SD 204 |
| 4 | 262 | 19.1 | 21.5 | 328 | 16.9 | 618 |
| | SD 171 | SD 1.6 | SD 1.8 | SD 50 | SD 2.2 | SD 52 |
| 5 | 437 | 9.3 | 18.4 | 440 | 220 | 232 |
| | SD 53 | SD 1.3 | SD 1.4 | SD 51 | SD 146 | SD 145 |
| 6 | 235 | 13.1 | 19.5 | 238 | 12.4 | 330 |
| | SD 35 | SD 2.0 | SD 1.7 | SD 32 | SD 2.3 | SD 183 |
| 8 | 346 | 6.3 | 9.4 | 356 | 5.8 | 160 |
| | SD 49 | SD 0.5 | SD 0.5 | SD 49 | SD 0.9 | SD 8 |
| 9 | 425 | 6.0 | 7.8 | 67.5 | 5.4 | 100 |
| | SD 34 | SD 0.4 | SD 0.3 | SD 6 | SD 0.3 | SD 6.8 |

BIONOLLE

| | | | | | | |
|---|---|---|---|---|---|---|
| 10 | 15.3 | 9.8 | 15.7 | 66.4 | 9.4 | 209 |
| | SD 1.9 | SD 0.9 | SD 0.4 | SD 13.7 | SD 0.7 | SD 7 |
| 11 | 15.9 | 11.7 | 17.6 | 71.4 | 10.8 | 234 |
| | SD 1.5 | SD 1.6 | SD 0.4 | SD 16.9 | SD 1.1 | SD 11 |
| 12 | 15.8 | 13.2 | 16.7 | 103 | 12.4 | 227 |
| | SD 2.7 | SD 1.2 | SD 1.1 | SD 12 | SD 1.0 | SD 11 |
| 13 | 17.7 | 11.8 | 15.9 | 107 | 10.9 | 205 |
| | SD 0.5 | SD 1.5 | SD 0.1 | SD 28 | SD 1.0 | SD 4.5 |
| 14 | 17.9 | 12.0 | 14.0 | 146 | 11.4 | 180 |
| | SD 2.0 | SD 0.4 | SD 0.3 | SD 7.8 | SD 0.3 | SD 12.5 |
| 15 | 76.5 | 7.7 | 11.1 | 130 | 7.4 | 159 |
| | SD 68 | SD .6 | SD 0.7 | SD 19 | SD 0.8 | SD 13 |

Nylon 11

| | | | | | | |
|---|---|---|---|---|---|---|
| 16 | 18.8 | 26.7 | 42.9 | 77.6 | 6.9 | 810 |
| | SD 2.7 | SD 3.1 | SD 0.6 | SD 27.1 | SD 2.0 | SD 39 |
| 17 | 305 | 34 | 46 | 305 | 34 | — |
| | SD 20 | SD 5 | SD 3 | SD 20 | SD 5 | |
| 19 | 353 | 32 | 45 | 355 | 28 | — |
| | SD 18 | SD 1 | SD 1 | SD 18 | SD 8 | |
| 20 | 341 | 32 | 41 | 342 | 32 | — |
| | SD 26 | SD 4 | SD 2 | SD 22 | SD 4 | |

Note:
Faster testing speed 150 mm/min

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of preparing a polymer composition, the method comprising melt mixing an aliphatic condensation polymer with a cyclic ester of general formula (I): 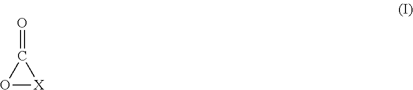
where X is an optionally substituted aliphatic hydrocarbon having 2 or more carbon atoms present in the cycle.

2. The method according to claim 1, wherein the aliphatic condensation polymer is selected from polyesters, polyamides, copolymers thereof, and blends thereof.

3. The method according to claim 2, wherein the polyesters are poly(hydroxyalkanoates).

4. The method according to claim 3, wherein the poly(hydroxyalkanoates) are selected from homo- and copolymers of poly(3-hydroxybutyrate), poly(4-hydroxybutyrate), poly(3-hydroxyvalerate), poly(lactic acid), poly(3-hydroxypropanoate), poly(4-hydropcntanoate), poly(3-hydroxypentanoate), poly(3-hydroxyhexanoate), poly(3-hydroxyheptanoate), poly(3-hydroxyoctanoate), polydioxanone, polycaprolactone, polyglycolic acid, and blends thereof.

5. The method according to claim 2, wherein the polyesters are a reaction product of one or more alkyldiols with one or more alkyldicarboxylic acids or their acyl derivatives.

6. The method according to claim 5, wherein the polyesters are a reaction product of (a) one or more alkyldicarboxylic acids selected from succinic acid, adipic acid, 1,12 dicarboxydodecane, fumaric acid, and maleic acid, and (b) one of more alkyldiols selected from ethylene glycol, polyethylene glycol, 1,2-propane diol, 1,3-propanediol, 1,2-propanediol, 1,2-butanediol, 1,3-butanediol, 1,4-butanediol, 1,6-hexanediol, diethylene glycol, and polypropylene glycol.

7. The method according to claim 6, wherein the polyesters are selected from polybutylenesuccinate homopolymer, polybutylene adipate homopolmer, polybutyleneadipate-succinate copolymer, polyethylenesuccinate-adipate copolymer, polyethylene adipate homopolymer, and blends thereof.

8. The method according to claim 2, wherein the polyamides are a reaction product of one or more alkyldiamines with one or more alkyldicarboxylic acids.

9. The method according to claim 8, wherein the polyamides are selected from poly(tetramethylene adipamide) (nylon 4,6), poly(hexamethylene adipamide) (nylon 6,6), poly(hexamethylene azelamide) (nylon 6,9), poly(hexamethylene sebacamide) (nylon 6,10), poly(heptamethylene pimelamide) (nylon 7,7), poly(octamethylene suberamide) (nylon 8,8), poly(nonamethylene azelamide) (nylon 9,9), and poly(decamethylene azelamide) (nylon 10,9).

10. The method according to claim 2, wherein the polyamides are a polymerised product of one or more alkylamino acids and/or lactam derivative thereof.

11. The method according to claim 10, wherein the polyamides are selected from poly(4-aminobutyric acid) (nylon 4), poly(6-aminohexanoic acid) (nylon 6), poly(7-amino-heptanoic acid) (nylon 7), poly(8-aminoocatanoic acid) (nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), and blends thereof.

12. The method according to claim 1, wherein X in formula (I) is an optionally substituted linear or branched alkylene, alkenylene, or alkynylene group.

13. The method according to claim 1, wherein X in formula (I) is an unsubstituted linear or branched alkylene, alkenylene, or alkynylene group.

14. The method according to claim 1, wherein X in formula (I) has 5 to 20 carbon atoms present in the cycle.

15. The method according to claim 1, wherein the cyclic ester of general formula (I) is a condensation residue of a hydroxycarboxylic acid of general formula (II): 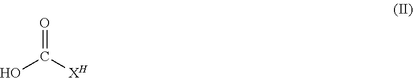
where X^{H} is a hydroxylated optionally substituted aliphatic hydrocarbon having two or more carbon atoms.

16. The method according to claim 15, wherein the
hydroxycarboxylic acid of general formula (II) is selected from hydroxy butyric acid, hydroxy valeric acid, hydroxy caproic acid, hydroxy caprylic acid, hydroxy pelargonic acid, hydroxy capric acid, hydroxy lauric acid, hydroxy mytistic acid, hydroxy palmitic acid, hydroxy margaric acid, hydroxy stearic acid, hydroxy arachidic acid, hydroxy behenic acid, hydroxy lignoceric acid, hydroxy cerotic acid, hydroxy carboceric acid, hydroxy montanic acid, hydroxy melissic acid, hydroxy lacceroic acid, hydroxy ceromelissic acid, hydroxy geddic acid, hydroxy ceroplastic acid, hydroxy obtusilic acid, hydroxy caproleic acid, hydroxy lauroleic acid, hydroxy linderic acid, hydroxy myristoleic acid, hydroxy physeteric acid, hydroxy tsuzuic acid, hydroxy palmitoleic acid, hydroxy sapienic acid, hydroxy petroselinic acid, hydroxy oleic acid, hydroxy elaidic acid, hydroxy vaccenic acid, hydroxy gadoleic acid, hydroxy gondoic acid, hydroxy cetoleic acid, hydroxy erucic acid, hydroxy nervonic acid, hydroxy linoleic acid, hydroxy γ-linolenic acid, hydroxy dihomo-γ-linolenic acid, hydroxy arachidonic acid, hydroxy linolenic acid, hydroxy steridonic acid, hydroxy nisinic acid, and hydroxy mead acid.

17. The method according to claim 1, wherein about 5 .wt % to about 35 wt. % of the cyclic ester is melt mixed with the aliphatic condensation polymer, relative to the total mass of the cyclic ester and the aliphatic condensation polymer.

18. The method according to claim 1, wherein the cyclic ester is provided in the form of a composition comprising one or more carrier polymers and the cyclic ester and/or a product formed by melt mixing a composition comprising one or more carrier polymers and the cyclic ester.

19. The method according to claim 18, wherein the cyclic ester composition is prepared by melt mixing a composition comprising the cyclic ester and the one or more carrier polymers.

20. The method according to claim 18, wherein the one or more carrier polymers is an aliphatic condensation polymer of the same type as the aliphatic condensation polymer used in claim 1.

21. The method according to claim 20, wherein about 30 .wt % to about 80 wt. % of the cyclic ester is melt mixed with the aliphatic condensation polymer, relative to the total mass of the cyclic ester and the aliphatic condensation polymer in the cyclic ester composition.

22. A polymer composition prepared by a method according to claim 1.

23. A polymer composition for modifying an aliphatic condensation polymer, the composition comprising one or more carrier polymers and a cyclic ester of general formula (I), and/or a product formed by melt mixing a composition comprising one or more carrier polymers and a cyclic ester of general formula (I): 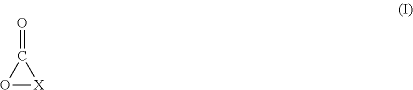
where X is an optionally substituted aliphatic hydrocarbon having 2 or more carbon atoms present in the cycle.

24. The polymer composition according to claim 23, wherein the one or more carrier polymers is an aliphatic condensation polymer.

25. The polymer composition according to claim 23, wherein the aliphatic condensation polymer is selected from polyesters, polyamides, copolymers thereof, and blends thereof.

26. The polymer composition according to claim 23, wherein X in formula (I) is an optionally substituted linear or branched alkylene, alkenylene, or alkynylene group.

27. The polymer composition according to claim 23, wherein the cyclic ester of general formula (I) is a condensation residue of a hydroxycarboxylic acid of general formula (II): 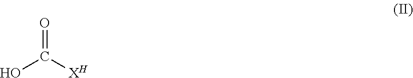
where X^{H} is a hydroxylated optionally substituted aliphatic hydrocarbon having two or more carbon atoms.

28. The polymer composition according to claim 27, wherein the hydroxycarboxylic acid of general formula (II) is selected from hydroxy butyric acid, hydroxy valeric acid, hydroxy caproic acid, hydroxy caprylic acid, hydroxy pelargonic acid, hydroxy capric acid, hydroxy lauric acid, hydroxy mytistic acid, hydroxy palmitic acid, hydroxy margaric acid, hydroxy stearic acid, hydroxy arachidic acid, hydroxy behenic acid, hydroxy lignoceric acid, hydroxy cerotic acid, hydroxy carboceric acid, hydroxy montanic acid, hydroxy melissic acid, hydroxy lacceroic acid, hydroxy ceromelissic acid, hydroxy geddic acid, hydroxy ceroplastic acid, hydroxy obtusilic acid, hydroxy caproleic acid, hydroxy lauroleic acid, hydroxy linderic acid, hydroxy myristoleic acid, hydroxy physeteric acid, hydroxy tsuzuic acid, hydroxy palmitoleic acid, hydroxy sapienic acid, hydroxy petroselinic acid, hydroxy oleic acid, hydroxy elaidic acid, hydroxy vaccenic acid, hydroxy gadoleic acid, hydroxy gondoic acid, hydroxy cetoleic acid, hydroxy erucic acid, hydroxy nervonic acid, hydroxy linoleic acid, hydroxy γ-linolenic acid, hydroxy dihomo-γ-linolenic acid, hydroxy arachidonic acid, hydroxy linolenic acid, hydroxy steridonic acid, hydroxy nisinic acid, and hydroxy mead acid.

29. A polymer composition comprising an aliphatic condensation polymer and a cyclic ester of general formula (I), and/or a product formed by melt mixing a composition comprising an aliphatic condensation polymer and a cyclic ester of general formula (I): 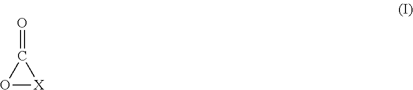
where X is an optionally substituted aliphatic hydrocarbon having 2 or more carbon atoms present in the cycle.
